(19) United States
(12) Patent Application Publication
(10) Pub. No.: US 2024/0305793 A1
(43) Pub. Date: Sep. 12, 2024

(54) VIDEO SIGNAL TRANSMISSION AND RECEPTION SYSTEM

(71) Applicant: LAPIS Technology Co., Ltd., Yokohama (JP)

(72) Inventor: Masaru SEKIGUCHI, Yokohama (JP)

(73) Assignee: LAPIS Technology Co., Ltd., Yokohama (JP)

(21) Appl. No.: 18/597,823

(22) Filed: Mar. 6, 2024

(30) Foreign Application Priority Data
Mar. 9, 2023 (JP) 2023-036981
Jan. 22, 2024 (JP) 2024-007648

(51) Int. Cl. H04N 19/164; H04N 19/186

(52) U.S. Cl. CPC H04N 19/164; H04N 19/186

(57) ABSTRACT

When performing back channel communication from a receiving side to a transmitting side of a composite video signal, accumulation of offset voltages of a differential amplifier circuit included in a back channel transmission circuit is suppressed.

A back channel transmission circuit performs back channel communication from a decoder to an encoder via a CVBS signal line by superimposing a pulse signal for back channel communication on a pedestal level of a composite video signal based on a pulse control signal from the decoder. The decoder inverts the polarity of a voltage generated by an offset voltage in operational amplifiers for outputting the pulse signal in the back channel transmission circuit every time the back channel transmission circuit is controlled to generate multiple pulse signals by outputting an inversion control signal to the back channel transmission circuit.

### CROSS-REFERENCE TO RELATED APPLICATION

This application claims the priority benefits of Japanese application no. 2023-036981, filed on Mar. 9, 2023, and Japanese application no. 2024-007648, filed on Jan. 22, 2024. The entirety of each of the above-mentioned patent applications is hereby incorporated by reference herein and made a part of this specification.

### BACKGROUND

### Technical Field

The disclosure relates to a video signal transmission and reception system that transmits and receives a composite video signal.

### Description of Related Art

Various systems have been proposed for transmitting and receiving video signals such as composite video signals between a transmitting side and a receiving side (for example, see Patent Literature 1 (Japanese Patent Application Laid-Open No. H03-208489)). In such a video signal transmission and reception system, when attempting to transmit various information such as a control signal from a receiving side to a transmitting side device, back channel communication may be used. In the back channel communication, control is performed such that a pulse signal is superimposed from the receiving side on a pedestal level of the section in which the video signal is not being transmitted or received in the composite video signal, and is transmitted in the opposite direction to the transmitting side.

However, when performing such back channel communication, if an offset voltage exists in the differential amplifier circuit included in the back channel transmission circuit that generates the pulse signal, the offset voltage is superimposed every time a pulse signal is superimposed on the composite video signal line. Further, there is no discharge path for the offset voltage superimposed on the composite video signal line. Therefore, if an offset voltage occurs when generating the next pulse signal, the offset voltage is accumulated and the voltage level of the composite video signal line deviates from the normal value thereof. When the accumulated offset voltage exceeds a certain level, erroneous data determination may be caused as the high level or low level of the pulse signal superimposed on the composite video signal line cannot be accurately determined. Furthermore, the brightness level of the received video signal may change due to the deviation in the pedestal level.

The disclosure provides a video signal transmission and reception system capable of suppressing accumulation of offset voltages of a differential amplifier circuit included in a back channel transmission circuit in a composite video signal line when performing back channel communication from a receiving side to a transmitting side of a composite video signal.

### SUMMARY

The video signal transmission and reception system of the disclosure includes an encoder which converts a Red-Green-Blue (RGB) video signal into a composite video signal;
a decoder which receives the composite video signal converted by the encoder via a composite video signal line and converts the composite video signal into the RGB video signal;
a back channel transmission circuit which has a differential amplifier circuit that outputs a pulse signal, and performs back channel communication from the decoder to the encoder via the composite video signal line by superimposing the pulse signal on a pedestal level of the composite video signal based on a pulse control signal from the decoder; and
a back channel receiving circuit which receives a pulse signal superimposed on the composite video signal line.

The decoder inverts polarity of an offset voltage generated in the differential amplifier circuit every time the back channel transmission circuit is controlled to generate multiple pulse signals.

### BRIEF DESCRIPTION OF THE DRAWINGS

FIG. 1 is a block diagram showing the configuration of a video signal transmission and reception system according to a first embodiment of the disclosure.

FIG. 2A and FIG. 2B are diagrams for describing how back channel communication is performed on a CVBS signal line.

FIG. 3 is a diagram showing a circuit configuration of a back channel transmission circuit 10 in the first embodiment of the disclosure.

FIG. 4 is a diagram showing a circuit configuration of operational amplifiers 12 and 13 shown in FIG. 3.

FIG. 5 is a diagram showing waveforms at a VX point and a VY point when no inversion control is performed.

FIG. 6 is a diagram showing waveforms at the VX point and the VY point when performing inversion control.

FIG. 7 is a block diagram showing the configuration of a video signal transmission and reception system according to a second embodiment of the disclosure.

FIG. 8A and FIG. 8B are diagrams for describing how a delay occurs in a pulse signal superimposed on a CVBS signal line.

FIG. 9 is a block diagram showing the configuration of a video signal monitor circuit 80 shown in FIG. 7.

FIG. 10 is a block diagram showing the configuration of a decoder 30A shown in FIG. 7.

FIG. 11 is a timing chart when voltage regulation is performed using a negative voltage regulation pulse.

FIG. 12 is a timing chart when voltage regulation is performed using a positive voltage regulation pulse.

### DESCRIPTION OF THE EMBODIMENTS

Next, embodiments of the disclosure will be described in detail with reference to the drawings.

### First Embodiment

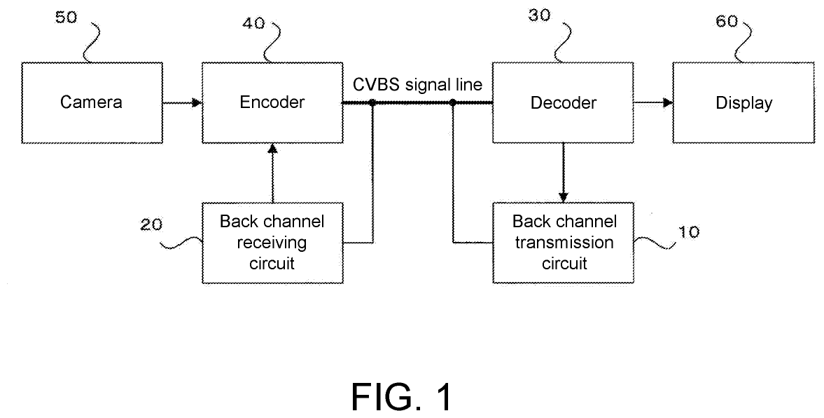

FIG. 1 is a block diagram showing the configuration of a video signal transmission and reception system according to a first embodiment of the disclosure.

The video signal transmission and reception system of the embodiment includes a back channel transmission circuit 10, a back channel receiving circuit 20, a decoder 30, an encoder 40, a camera 50, and a display 60.

The video signal transmission and reception system shown in FIG. 1 is a system in which an RGB video signal from the camera 50 is displayed on the display 60 via the encoder 40, a Composite Video Blanking and Sync (CVBS) signal line, and the decoder 30.

The encoder 40 converts the RGB video signal from camera 50 into a composite video signal. Also, the decoder 30 receives the composite video signal converted by the encoder 40 via the CVBS signal line, which is a composite video signal line, and converts the composite video signal into the RGB video signal.

Therefore, the RGB video signal photographed by the camera 50 is converted into a composite video signal by the encoder 40, and the decoder 30 converts the composite video signal back into the RGB video signal and displays the RGB video signal on the display 60.

In such a video signal transmission and reception system, there are cases where it is exemplary to control the encoder 40 on the transmitting side from the decoder 30 on the receiving side. For example, there may be cases where it is exemplary to read/write registers in the encoder from the decoder 30, to control a Serial Peripheral Interface (SPI) flash memory connected to the encoder 40, and to read/write to/from another device connected to an I2C bus to which the encoder 40 is connected.

In order to achieve such a purpose, in the video signal transmission and reception system of the embodiment, the back channel transmission circuit 10 is connected to the decoder 30, and the back channel receiving circuit 20 is connected to the encoder 40, allowing back channel communication.

In the back channel communication, data such as a pulse signal is transmitted from the back channel transmission circuit 10 on the decoder 30 side to the back channel receiving circuit on the encoder 40 side via the CVBS signal line using a section other than the section where the video signal is being transmitted.

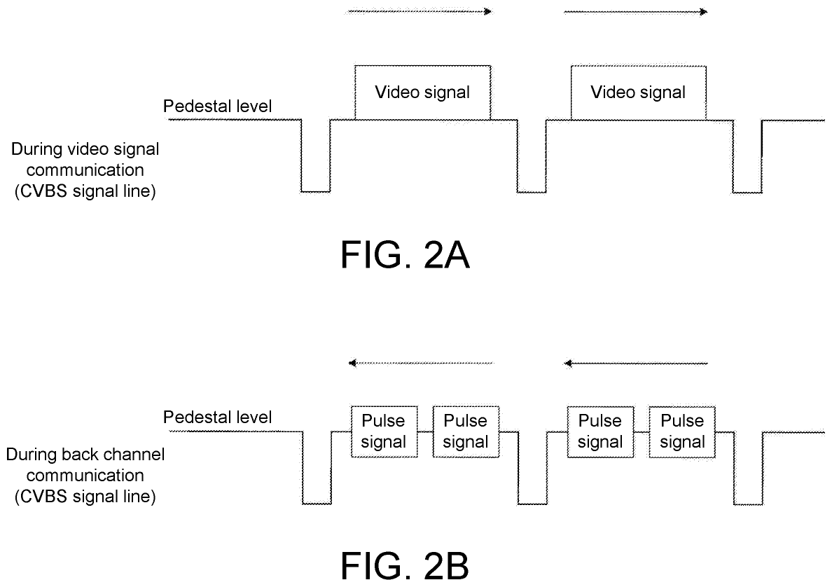

The manner in which the back channel communication is performed will be described with reference to FIGS. 2A and 2B.

FIG. 2A is a schematic diagram showing a waveform on the CVBS signal line during normal video signal communication. Referring to FIG. 2A, during the normal video signal communication, it can be seen that the composite video signal is superimposed on the pedestal level and transmitted from the encoder 40 side to the decoder 30 side.

FIG. 2B is a schematic diagram showing a waveform on the CVBS signal line during back channel communication. Referring to FIG. 2B, during the back channel communication, it can be seen that a pulse signal generated by the back channel transmission circuit 10 is superimposed on the pedestal level and is transmitted from the decoder 30 side to the encoder 40 side.

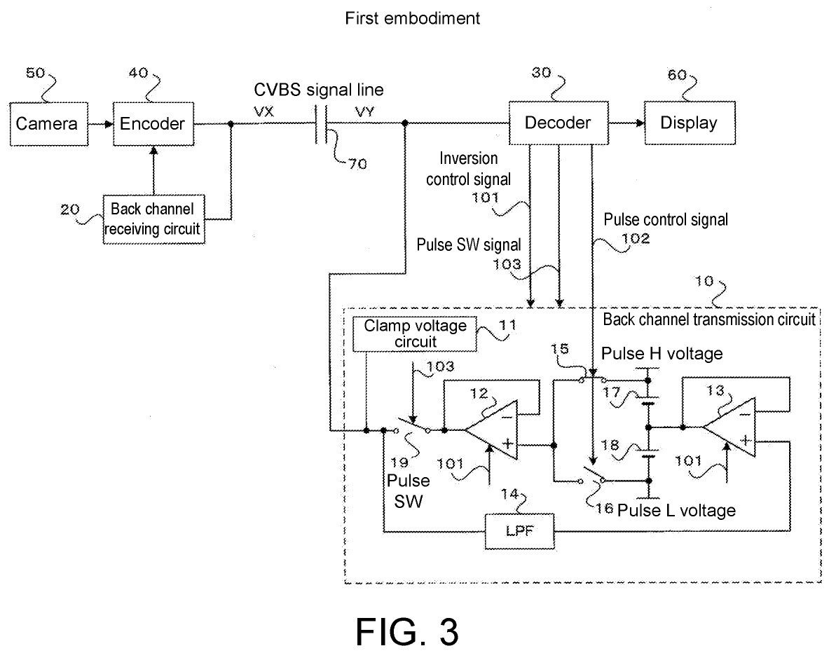

Next, FIG. 3 shows the circuit configuration of the back channel transmission circuit 10 in the embodiment.

The back channel transmission circuit 10, as shown in FIG. 3, is formed by a clamp voltage circuit 11, operational amplifiers (differential amplifier circuits) 12 and 13, a Low Pass Filter (LPF) 14, switch elements 15 and 16, voltage sources 17 and 18, and a pulse switch (abbreviated as pulse SW) 19.

As shown in FIG. 3, a coupling capacitor 70 is provided in the middle of the CVBS signal line. Such a disposition is provided to absorb a direct current voltage difference between the encoder 40 and the decoder 30, remove each of direct current components (DC components), and transmit merely the alternating current component (AC component).

Note that the point between the coupling capacitor 70 and the encoder 40 is described as a VX point, and the point between the coupling capacitor 70 and the decoder 30 is described as a VY point.

Next, the description is made assuming that at the VX point, the pedestal level is set to 0.284V, and at the VY point, the pedestal level is set to, for example, a voltage obtained by adding 0.284V to a clamp voltage of 1.1V, for example, 1.384V.

Here, when an offset voltage is generated in the operational amplifiers 12 and 13 in the back channel transmission circuit 10, the offset voltage is applied to the VY point of the CVBS signal line. Then, the coupling capacitor 70 is charged with electric charge, so that the applied offset voltage remains held.

Therefore, the video signal transmission and reception system of the embodiment has a circuit configuration as described below to suppress the accumulation of offset voltages on the CVBS signal line.

The decoder 30 outputs a pulse control signal 102 for generating a pulse signal for back channel communication to the back channel transmission circuit 10. The back channel transmission circuit 10 has the operational amplifiers 12 and 13 that output pulse signals, and performs back channel communication from the decoder 30 to the encoder 40 via the CVBS signal line by superimposing a pulse signal for back channel communication on the pedestal level of the composite video signal based on the pulse control signal 102 from the decoder 30. Then, the back channel receiving circuit 20 receives the pulse signal superimposed on the CVBS signal line. Further, the decoder 30 outputs a pulse SW signal 103 to the back channel transmission

circuit 10 for controlling the pulse SW 19 in the back channel transmission circuit 10. The pulse SW 19 is in a closed state when the pulse SW signal 103 is at a high level (hereinafter abbreviated as H level), and is in an open state when the pulse SW signal 103 is at a low level (hereinafter abbreviated as L level). In other words, the pulse signal from the back channel transmission circuit 10 is superimposed on the CVBS signal line merely when the pulse SW signal 103 is generated.

Further, the decoder 30 outputs an inversion control signal 101 to the back channel transmission circuit 10. The decoder 30 inverts the polarity of the offset voltage generated in operational amplifiers 12 and 13 for outputting pulse signals in the back channel transmission circuit 10 every time the back channel transmission circuit 10 is controlled to generate multiple pulse signals by outputting the inversion control signal 101 to the back channel transmission circuit 10.

Next, the operation of the back channel transmission circuit 10 will be described with reference to FIG. 3.

In the back channel transmission circuit 10, the pedestal level of the CVBS signal line is monitored by the operational amplifier 13. Specifically, the voltage at the VY point of the CVBS signal line is input to a non-inverting input terminal of the operational amplifier 13 via the LPF 14. The LPF 14 removes the pulse signal on the CVBS signal line, passes merely the DC component, and inputs the DC component to the non-inverting input terminal of the operational amplifier 13. Since an output terminal and an inverting input terminal of the operational amplifier 13 are electrically connected, the operational amplifier 13 functions as a buffer circuit with an amplification factor of 1. As a result, the output terminal of the operational amplifier 13 outputs a voltage at the pedestal level at the VY point. Note that the VY point of the CVBS signal line is clamped to a clamp voltage by the clamp voltage circuit 11. For example, the VY point of the CVBS signal line is clamped to 1.1V by the clamp voltage circuit 11.

Therefore, the pedestal level of the composite video signal output from the encoder 40 is 0.284V, but the pedestal level at the VY point is 1.384V (0.284V+1.1V).

Then, the voltage obtained by adding the voltage of the voltage source 17 to the pedestal level output from the output terminal of the operational amplifier 13 becomes a pulse H voltage, and the voltage obtained by subtracting the voltage of the voltage source 18 becomes a pulse L voltage. The pulse H voltage is the voltage when the pulse signal is at the H level. Further, the pulse L voltage is the voltage when the pulse signal is at the L level. For example, if the voltage sources 17 and 18 each have a voltage of 0.5V, the pulse H voltage is 1.884V, which is 1.384V plus 0.5V. Also, the pulse L voltage is 0.884V, which is obtained by subtracting 0.5V from 1.384V.

The switch element 15 is in a closed state when the pulse control signal 102 is at the H level, and is in an open state when the pulse control signal 102 is at the L level. Further, the switch element 16 is in an open state when the pulse control signal 102 is at the H level, and is in a closed state when the pulse control signal 102 is at the L level.

Since an output terminal and an inverting input terminal of the operational amplifier 12 are electrically connected, the operational amplifier 12 also functions as a buffer circuit with an amplification factor of 1. As a result, when the pulse control signal 102 is at the H level, a pulse signal that becomes the pulse H voltage is output from an output terminal of the operational amplifier 12; when the pulse control signal 102 is at the L level, a pulse signal that becomes the pulse L voltage is output from the output terminal of the operational amplifier 12.

In this way, the back channel transmission circuit 10 generates a pulse signal of pulse H voltage/pulse L voltage based on the pulse control signal 102 from the decoder 30 with the pedestal level as a reference, and superimposes the pulse signal on the CVBS signal line.

The decoder 30 then outputs the inversion control signal 101 every time the back channel transmission circuit 10 is controlled to generate multiple pulse signals. Further, the inversion control signal 101 from the decoder 30 is input to the operational amplifiers 12 and 13.

Therefore, the operational amplifiers 12 and 13 each invert the polarity of the offset voltage generated by switching the circuit configurations of a non-inverting input terminal, an inverting input terminal, and an output terminal based on the inversion control signal 101.

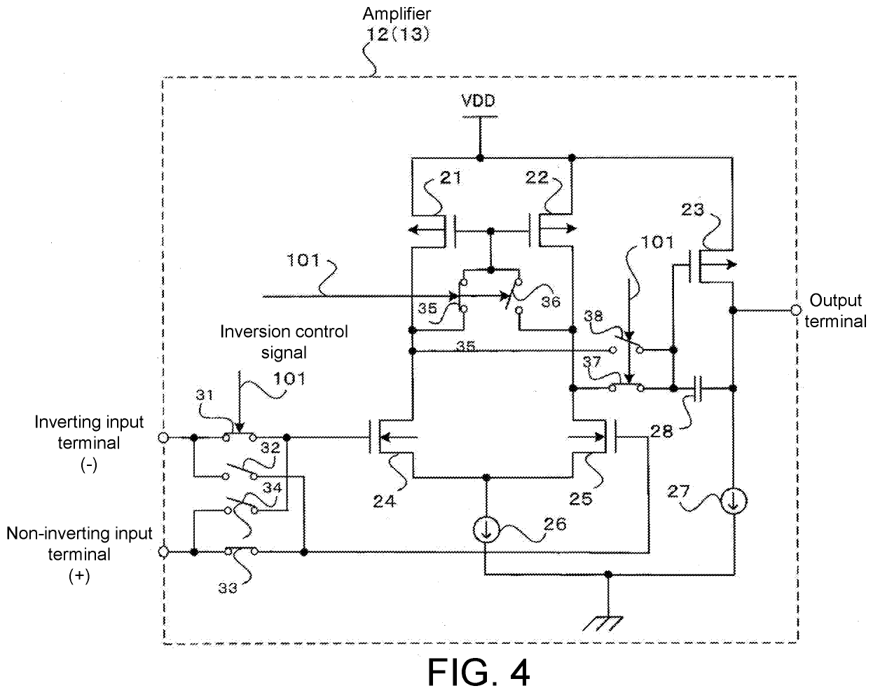

Next, the circuit configurations of the operational amplifiers 12 and 13 shown in FIG. 3 is shown in FIG. 4.

Since the circuit configurations of the operational amplifiers 12 and 13 are the same, merely the circuit configuration of the operational amplifier 12 will be described in the following description.

The operational amplifier 12, as shown in FIG. 4, is formed by P-channel field-effect transistors (FETs) 21, 22, and 23, N-channel FETs 24 and 25, current sources 26 and 27, a capacitor 28, and switch elements 31 to 38.

Then, the P-channel FETs 21, 22, and 23, the N-channel FETs 24 and 25, the current sources 26 and 27, and the capacitor 28 constitute a differential amplifier circuit having an inverting input terminal (−), a non-inverting input terminal (+), and an output terminal.

The switch elements 31, 33, 35, and 37 are in a close state when the inversion control signal 101 is at the H level, and are in an open state when the inversion control signal 101 is at the L level. Further, the switch elements 32, 34, 36, and 38 are in an open state when the inversion control signal 101 is at the H level, and are in a closed state when the inversion control signal 101 is at the L level.

Therefore, by switching the inversion control signal 101 between the H level and the L level, the circuit configuration of the operational amplifier 12 is switched between the positive side and the negative side, and the polarity of the generated offset voltage is inverted. In this way, the operational amplifier 12 has the switch elements 31 to 38 that switch circuit configurations of the non-inverting input terminal, the inverting input terminal, and the output terminal based on the inversion control signal 101.

When causing the back channel transmission circuit 10 to generate a pulse signal group formed by multiple pulse signals, the decoder 30 switches the logic of the inversion control signal 101 every time a pulse signal group is generated and inverts the polarity of the generated offset voltage.

As a result, even if an offset voltage occurs when a certain pulse signal group is generated, the offset voltage is canceled out by the offset voltage of the opposite polarity when the next pulse signal group is generated.

Next, how the offset voltage is canceled out by such control will be described with reference to the drawings. In the following description, a case will be described in which the total offset voltage from the operational amplifiers 12 and 13 is in the positive direction.

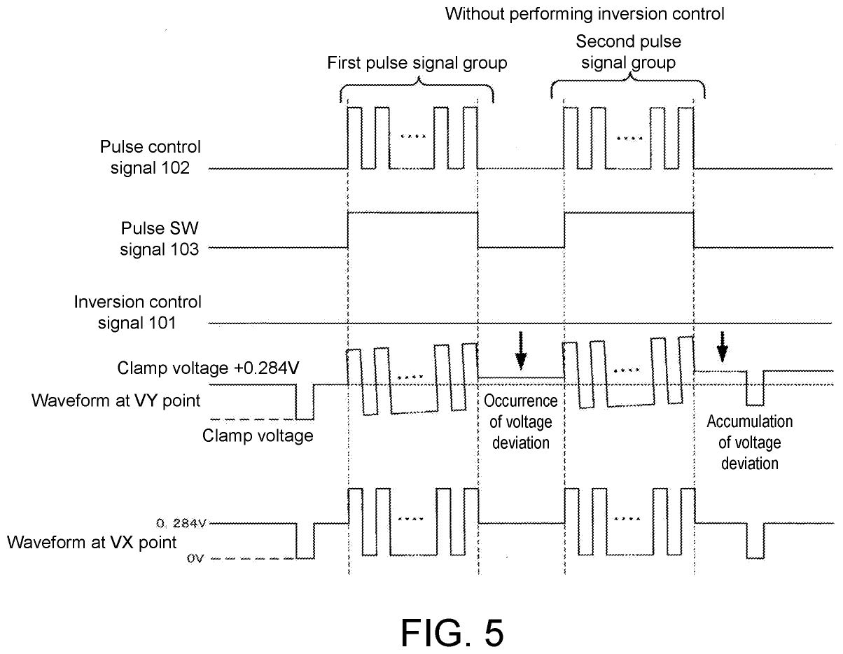

First, the waveforms at the VX point and the VY point when no inversion control is performed will be described with reference to FIG. 5.

In FIG. 5, the inversion control signal 101 is fixed at the L level and no inversion control is performed. Therefore, it can be seen that if the voltage at the VY point deviates from the clamp voltage +0.284V due to the offset voltage when the first pulse signal group is generated, the offset voltage when generating the second pulse signal group causes further deviation. In other words, it can be seen that the generated offset voltage is accumulated.

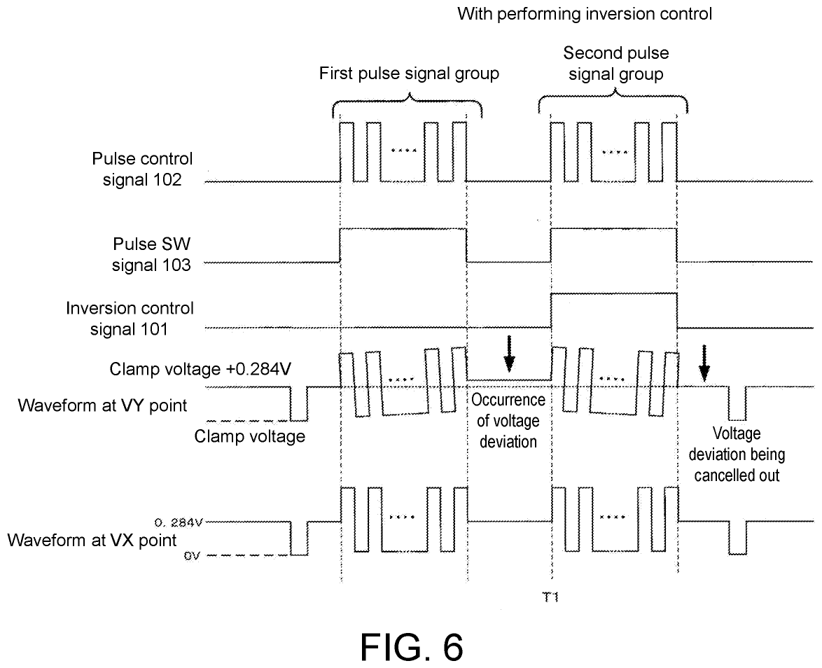

Next, the waveforms at the VX point and the VY point when performing inversion control will be described with reference to FIG. 6.

In FIG. 6, the inversion control signal 101 is at the L level when the first pulse signal group is generated, but becomes the H level at time TI which is the timing at which the second pulse signal group is generated, and inversion control is being performed. Therefore, it can be seen that even when the voltage at the VY point deviates from the clamp voltage +0.284V due to the offset voltage when the first pulse signal group was generated, the voltage is canceled out by the offset voltage when the second pulse signal group is generated and returns to the original voltage.

In this way, in the video signal transmission and reception system of the embodiment, control is performed to invert the polarity of the offset voltage generated in the operational amplifiers 12 and 13 every time a pulse signal group formed by multiple pulse signals is generated. As a result, according to the embodiment, when performing back channel communication from the receiving side to the transmitting side of the composite video signal, the offset voltage of the operational amplifiers 12 and 13 included in the back channel transmission circuit 10 may be suppressed from being accumulated on the CVBS signal line.

Note that the offset voltage held at the VY point of the CVBS signal line when generating a certain pulse signal group is canceled out by the offset voltage of the opposite polarity that occurs when generating the next pulse signal group, but if the number of pulse signal groups to be generated is an odd number, the offset voltage caused by the last generated pulse signal group remains on the CVBS signal line without being canceled out.

Therefore, during the period when the composite video signal is not superimposed on the CVBS signal line, the decoder 30 controls the back channel transmission circuit 10 so that the number of times the back channel transmission circuit 10 is controlled to generate a pulse signal group formed by multiple pulse signals and to superimpose the pulse signal group on the CVBS signal line is an even number.

As a result, the voltage deviation caused by the offset voltage may be suppressed from remaining on the CVBS signal line.

### Second Embodiment

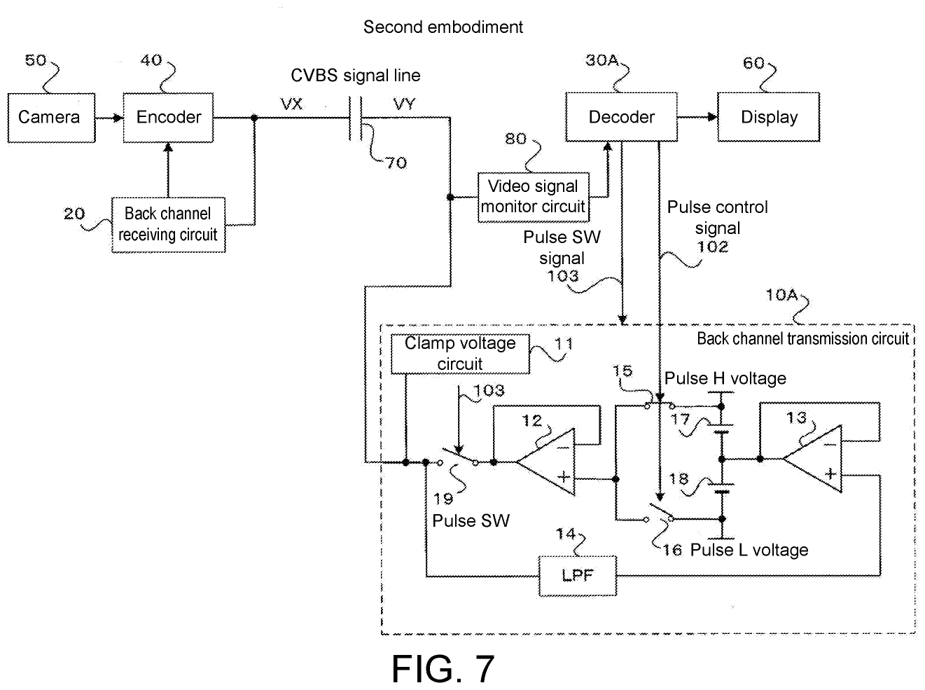

Next, an image display system according to a second embodiment of the disclosure will be described. FIG. 7 is a block diagram showing the configuration of a video signal transmission and reception system according to the second embodiment of the disclosure.

As shown in FIG. 7, the image display system of the embodiment differs from the first embodiment described above merely in that the back channel transmission circuit 10 and decoder are replaced with a back channel transmission circuit 10A and a decoder 30A, respectively, and a video signal monitor circuit 80 is added. Therefore, in the description of the image display system of the embodiment, merely the circuit configuration that is different from the first embodiment described above will be described.

Note that the back channel transmission circuit 10A in the embodiment differs from the back channel transmission circuit 10 in the first embodiment shown in FIG. 3 in that although the circuit configuration is such that the function of inversion control using the inversion control signal 101 is removed, the other circuit configurations are the same, so detailed descriptions will be omitted.

In the image display system of the first embodiment described above, by performing control to invert the polarity of the offset voltage generated in the operational amplifiers 12 and 13 every time a pulse signal group formed by multiple pulse signals is generated, the offset voltage of the operational amplifiers 12 and 13 included in the back channel transmission circuit 10 was suppressed from being accumulated on the CVBS signal line. However, even if no offset voltage occurs in the operational amplifiers 12 and 13, if the pulse signal continues to be superimposed on the CVBS signal line, the voltage of the CVBS signal line may deviate from an ideal voltage.

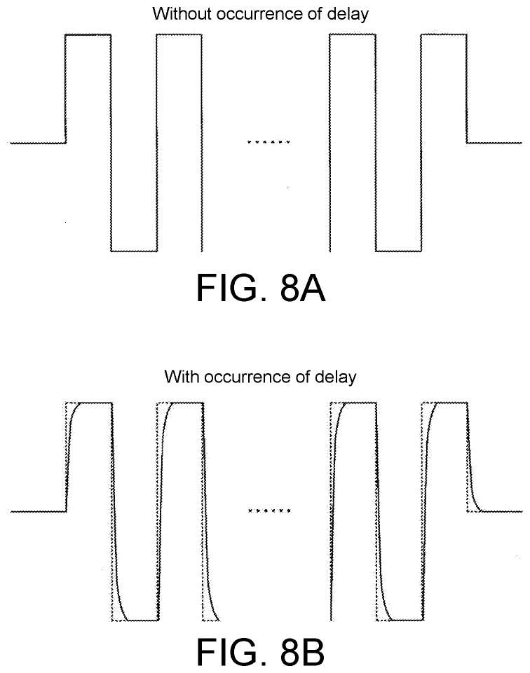

For example, a pulse signal superimposed on a CVBS signal line has a delay at both the rising and falling timings. The manner in which a delay occurs in the pulse signal superimposed on the CVBS signal line will be described with reference to FIGS. 8A and 8B.

FIG. 8A is a diagram showing an ideal state in which no delay occurs in the pulse signal. On the other hand, FIG. 8B is a diagram showing a state in which a delay occurs at both the rising and falling timings of the pulse signal. When a delay occurs in the pulse signal as shown in FIG. 8B, the voltage of the CVBS signal line deviates from the normal voltage due to the difference in the rise/fall delay of the pulse signal. Specifically, if the area of the positive pulse signal is wider than the area of the negative pulse signal, a positive voltage deviation occurs in the CVBS signal line. Furthermore, if the area of the negative pulse signal is wider than the area of the positive pulse signal, a negative voltage deviation occurs in the CVBS signal line. Then, every time a pulse signal is superimposed on the CVBS signal line, a voltage deviation occurs, and the voltage deviation is accumulated in the CVBS signal line.

Therefore, the decoder 30A in the embodiment detects a voltage change by comparing the voltages of the CVBS signal line before and after multiple pulse signals are superimposed, and controls the back channel transmission circuit 10A to generate a pulse signal that cancels out the detected voltage change and to superimpose the pulse signal on the CVBS signal line.

In the image display system of the embodiment, by performing such control, the voltage deviation occurring in the CVBS signal line is canceled out, and the voltage of the CVBS signal line is maintained at a normal voltage.

Specifically, if the voltage of the CVBS signal line after the pulse signals are superimposed is higher than the voltage of the CVBS signal line before the pulse signals are superimposed, the decoder 30A controls the back channel transmission circuit 10A to generate a negative voltage regulation pulse signal having a voltage lower than the pedestal level and to superimpose the negative voltage regulation pulse signal on the CVBS signal line. If the voltage of the CVBS signal line after the pulse signals are superimposed is lower than the voltage of the CVBS signal line before the pulse signals are superimposed, the decoder 30A controls the back channel transmission circuit 10A to generate a positive voltage regulation pulse signal having a voltage higher than the pedestal level and to superimpose the positive voltage regulation pulse signal on the CVBS signal line.

Next, the specific configuration of each of blocks in the image display system of the embodiment shown in FIG. 7 will be described.

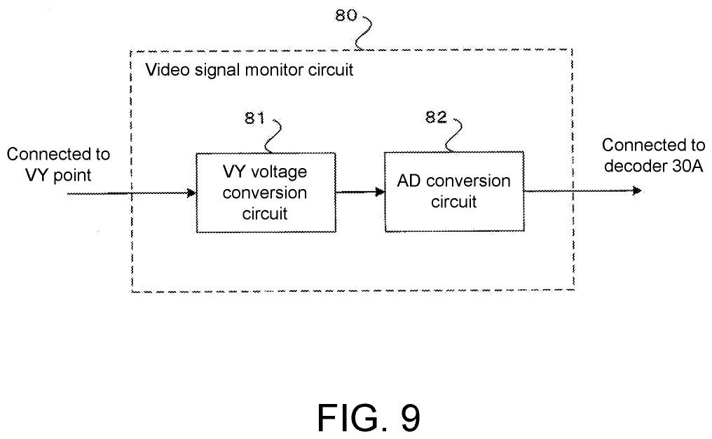

First, the configuration of the video signal monitor circuit 80 shown in FIG. 7 is shown in the block diagram of FIG. 9.

The video signal monitor circuit 80 constantly measures the voltage at the VY point of the CVBS signal line in real time and outputs the measurement result to the decoder 30A, and the video signal monitor circuit 80, as shown in FIG. 9, is formed by a VY voltage conversion circuit 81 and an AD conversion circuit 82.

The VY voltage conversion circuit 81 converts the voltage at the VY point to a voltage within the dynamic range of the AD conversion circuit 82. The AD conversion circuit 82 digitally converts an output voltage value from the VY voltage conversion circuit 81 and outputs the output voltage value to the decoder 30A.

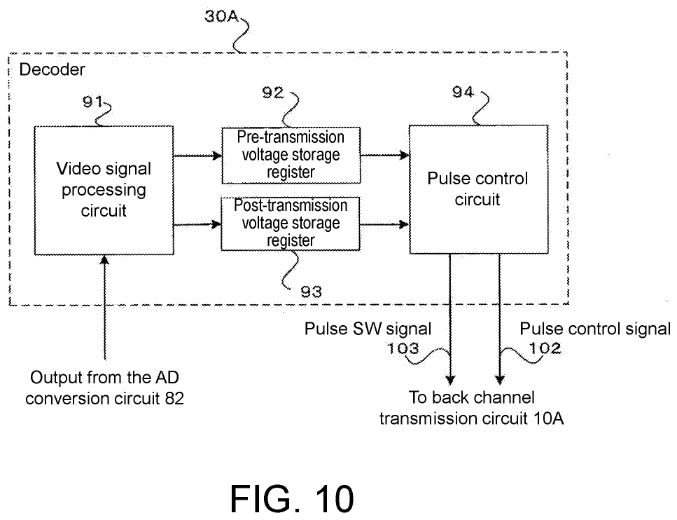

Next, the configuration of the decoder 30A shown in FIG. 7 is shown in the block diagram of FIG. 10. Note that, in FIG. 10, among the circuit configurations constituting the decoder 30A, the circuit configuration for converting the composite video signal from the CVBS signal line into the RGB video signal is omitted.

The decoder 30A, as shown in FIG. 10, includes a video signal processing circuit 91, a pre-transmission voltage storage register 92, a post-transmission voltage storage register 93, and a pulse control circuit 94.

The video signal processing circuit 91 monitors the voltage at the VY point of the CVBS signal line based on the output from the AD conversion circuit 82, writes the voltage value of the VY point before the pulse signal is output in the pre-transmission voltage storage register 92, and writes the voltage value at point VY after the pulse signal is output in the post-transmission voltage storage register 93.

During normal operation, the pulse control circuit 94 uses the pulse control signal 102 and the pulse SW signal 103 and controls the back channel transmission circuit 10A to generate a pulse signal. After outputting the pulse signals to the CVBS signal line, the pulse control circuit 94 detects the voltage deviation of the pedestal level of the CVBS signal line by comparing the voltage value stored in the pre-transmission voltage storage register 92 and the voltage value stored in the post-transmission voltage storage register 93.

If the voltage value stored in the post-transmission voltage storage register 93 is larger than the voltage value stored in the pre-transmission voltage storage register 92, the pulse control circuit 94 determines that a voltage deviation in the positive direction has occurred in the CVBS signal line, and controls the back channel transmission circuit 10A to generate a negative voltage regulation pulse. Furthermore, if the voltage value stored in the post-transmission voltage storage register 93 is smaller than the voltage value stored in the pre-transmission voltage storage register 92, the pulse control circuit 94 determines that a voltage deviation in the negative direction has occurred in the CVBS signal line, and controls the back channel transmission circuit 10A to generate a positive voltage regulation pulse.

With such kind of control, the voltage deviation generated in the CVBS signal line due to the difference in rise/fall times of multiple pulse signals is canceled out by the voltage regulation pulse, and the voltage deviation becomes zero. Note that the pulse control circuit 94 performs control so that the detected voltage change is canceled out and the generated voltage deviation becomes zero by changing the time width of the output voltage regulation pulse according to the difference between the voltage values before and after the pulse signal is superimposed. In other words, the pulse control circuit 94 controls the back channel transmission circuit 10A so that if the difference between the voltage values before and after the pulse signal is transmitted is large, a voltage regulation pulse with a long time width is generated, and if the difference between the voltage values before and after the pulse signal is transmitted is small, a voltage regulation pulse with a short time width is generated.

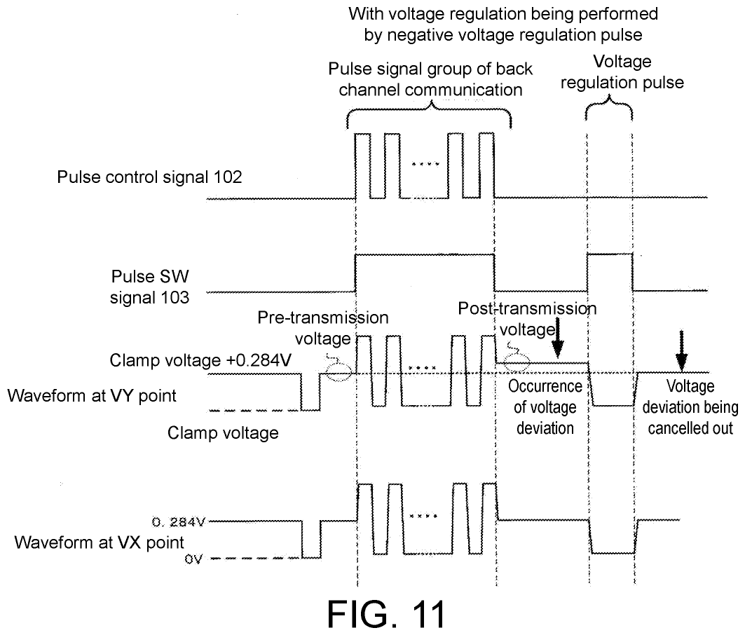

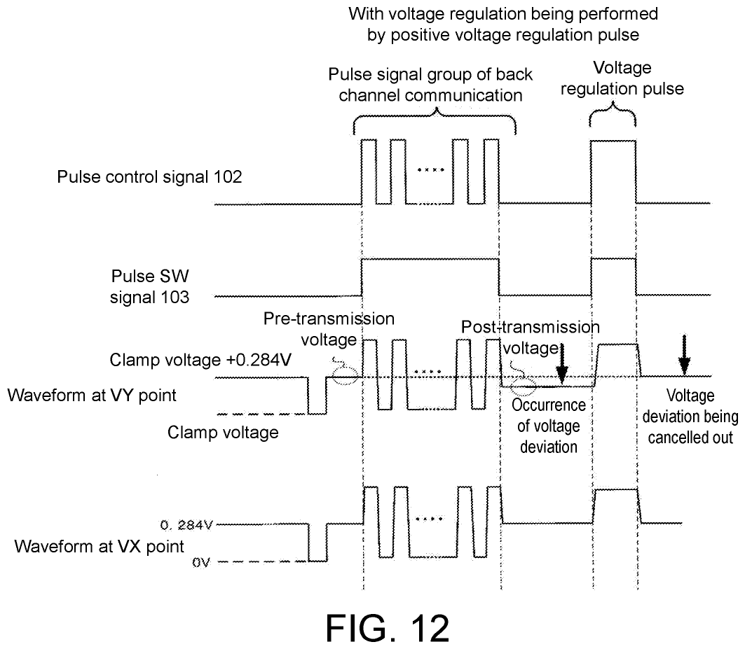

Timing charts when such control is performed are shown in FIGS. 11 and 12. FIG. 11 is a timing chart when voltage regulation is performed using a negative voltage regulation pulse. Further, FIG. 12 is a timing chart when voltage regulation is performed using a positive voltage regulation pulse.

The timing chart shown in FIG. 11 shows a case where a positive voltage deviation occurs due to a difference in rise/fall delay time of multiple pulse signals output to the CVBS signal line. Therefore, it can be seen that the pulse control circuit 94 of the decoder 30A sets the pulse SW signal 103 to the H level while keeping the pulse control signal 102 at the L level, and a negative voltage regulation pulse is generated. It can be seen that the negative voltage regulation pulse cancels out the positive voltage deviation that occurred after the output of the pulse signals, and the VY point of the CVBS signal line returns to the original pedestal level voltage.

Also, the timing chart shown in FIG. 12 shows a case where a negative voltage deviation occurs due to a difference in rise/fall delay time of multiple pulse signals output to the CVBS signal line. Therefore, it can be seen that the pulse control circuit 94 of the decoder 30A sets the pulse control signal 102 to the H level, and sets the pulse SW signal 103 to the H level, and a positive voltage regulation pulse is generated. It can be seen that the positive voltage regulation pulse cancels out the negative voltage deviation that occurred after the output of the pulse signals, and the VY point of the CVBS signal line returns to the original pedestal level voltage.

In this way, according to the image display system of the embodiment, the voltage deviation of the CVBS signal line caused by the pulse signals being output may be canceled out by using the voltage regulation pulse.

Note that in the embodiment, the description has been made regarding the case where the configuration is configured independently of the first embodiment in which control is performed to invert the polarity of the offset voltage generated in the operational amplifiers 12 and 13 every time a pulse signal is output. However, the configuration according to the first embodiment may also be combined with the configuration according to the embodiment to perform control of both.

What is claimed is:

1. A video signal transmission and reception system, comprising:
an encoder, converting an RGB video signal into a composite video signal;
a decoder, receiving the composite video signal converted by the encoder via a composite video signal line and converting the composite video signal into the RGB video signal;
a back channel transmission circuit, having a differential amplifier circuit that outputs a pulse signal, and performing back channel communication from the decoder to the encoder via the composite video signal line by superimposing the pulse signal on a pedestal level of the composite video signal based on a pulse control signal from the decoder; and
a back channel receiving circuit, receiving the pulse signal superimposed on the composite video signal line, wherein
the decoder inverts polarity of an offset voltage generated in the differential amplifier circuit every time the back channel transmission circuit is controlled to generate a plurality of pulse signals.

2. The video signal transmission and reception system according to claim 1, wherein
the decoder outputs an inversion control signal every time the back channel transmission circuit is controlled to generate the plurality of pulse signals, and
the differential amplifier circuit comprises a plurality of switch elements that switch circuit configurations of a non-inverting input terminal, an inverting input terminal, and an output terminal based on the inversion control signal.

3. The video signal transmission and reception system according to claim 1, wherein the decoder, during a period when the composite video signal is not superimposed on the composite video signal line, controls the back channel transmission circuit so that the number of times the back channel transmission circuit is controlled to generate the plurality of pulse signals and to superimpose the plurality of pulse signals on the composite video signal line is an even number.

4. The video signal transmission and reception system according to claim 1, wherein the decoder detects a voltage change by comparing voltages of the composite video signal line before and after the plurality of pulse signals are superimposed, and controls the back channel transmission circuit to generate a pulse signal that cancels out the voltage change detected and to superimpose the pulse signal on the composite video signal line.

5. The video signal transmission and reception system according to claim 4, wherein
the decoder controls the back channel transmission circuit to generate a negative voltage regulation pulse signal having a voltage lower than the pedestal level and to superimpose the negative voltage regulation pulse signal on the composite video signal line when the voltage of the composite video signal line after the plurality of pulse signals are superimposed is higher than the voltage of the composite video signal line before the plurality of pulse signals are superimposed, and controls the back channel transmission circuit to generate a positive voltage regulation pulse signal having a voltage higher than the pedestal level and to superimpose the positive voltage regulation pulse signal on the composite video signal line when the voltage of the composite video signal line after the plurality of pulse signals are superimposed is lower than the voltage of the composite video signal line before the plurality of pulse signals are superimposed.

6. The video signal transmission and reception system according to claim 5, wherein
the decoder, depending on a voltage difference between the composite video signal line before and after the plurality of pulse signals are superimposed, performs control so that the voltage change detected is canceled out by changing a time width of a voltage regulation pulse signal that is output.
